(19) United States
(12) Patent Application Publication
(10) Pub. No.: US 2016/0229631 A1
(43) Pub. Date: Aug. 11, 2016

(54) Picking System

(71) Applicant: HITACHI, LTD., Chiyoda-ku, Tokyo (JP)

(72) Inventors: Junichi KIMURA, Tokyo (JP); Yoriko KAZAMA, Tokyo (JP)

(21) Appl. No.: 15/023,144

(22) PCT Filed: Dec. 24, 2013
(86) PCT No.: PCT/JP2013/084429

§ 371 Date: Mar. 18, 2016

(51) Int. Cl. B65G 1/10; B65G 1/137; B65G 1/04

(52) U.S. Cl. CPC B65G 1/10; B65G 1/0492; B65G 1/1373

(57) ABSTRACT

This picking system comprises a mobile rack that can be moved, an automated guided vehicle (AGV) that transports the mobile rack, an AGV area in which the AGV transports the mobile rack, a picking area that abuts the AGV area and in which workers perform picking, and two or more picking locations that are locations that abut the picking area in the AGV area and in which the mobile rack is placed temporarily. The picking system has a function to detect that the mobile rack from which to pick is placed at the picking location and notify the picking terminal to perform the picking from the mobile rack that picking is possible.

### TECHNICAL FIELD

The present invention relates to a picking system using a vehicle.

### BACKGROUND ART

In recent years, the movement of stored goods in the warehouse has been significantly automated. For example, in a large warehouse, automated guided vehicles move the goods stored in the warehouse.

In an example of Patent Literature 1, in a warehouse, “inventory holders” in which products are stored are arranged in a lattice fashion. Then, a “movement drive unit” automatically runs along the aisles between the inventory holders, lifts up an “inventory holder”, and moves the product to an “inventory station” in which picking is performed. Then, a human operator takes the intended “inventory item” in the “inventory station”.

Further, in an example of Patent Literature 2, in a warehouse, an “automated guided vehicle” transports a “bucket”, in which parts are stored, to the position of a “line side station” in a “cell” that corresponds to the inventory station described above, and then an assembly worker receives the parts.

### CITATION

### Patent Literature

Patent Literature 1: Japanese Unexamined Patent Application Publication (Translation of PCT Application) No. 2009-513457 (Paragraphs 0009, 0022, and so on)
Patent Literature 2: Japanese Patent Application Laid-Open No. 2003-137406 (Paragraphs 0031, 0033, and so on)

### SUMMARY OF INVENTION

### Technical Problem

The amount of goods in a warehouse changes every day or from time to time. The problem that the invention aims to solve is to achieve an effective picking system that can handle such a change in the goods, or in other words, a picking system that can pick much more products or parts per unit time, by effectively controlling automatic guided vehicles.

The technology in Patent Literature 1 can address the change in the amount of goods to be processed by increasing the number of automated guided vehicles as well as the number of “inventory stations”. However, unused automated guided vehicles and unused “inventory stations” exist during the period in which the amount of goods is small, and it is wasteful in terms of management. In addition, in the technology in Patent Literature 1, waiting time occurs for the picking worker and the efficiency is reduced.

The technology in Patent Literature 2 can respond to increasing or decreasing the amount of goods to a certain extent by changing the number of workers who work in the “cell”. However, the upper limit of the amount of goods that can be processed is limited by the number of automated guided vehicles.

Under these circumstances, an object of the present invention is to achieve an effective picking system in such a way that the area in which automated guided vehicles transport racks is separated from the area in which workers perform picking and that the boundary of the areas is changed according to the amount of goods.

### Solution to Problem

In order to achieve the above object, the present invention adopts the structure described in the claims.

The present invention includes a plurality of means for solving the above problems. One example of the picking system of the present invention is a picking system characterized by having including: a mobile rack that can be moved; an automated guided vehicle (hereinafter, AGV) for transporting the movable rack; an AGV area in which the AGV transports the movable rack; a picking area that abuts the AGV area and is provided for workers to perform picking operations; two or more picking locations, each of which is located within the AGV area in the position abutting the picking area to temporarily place the movable rack.

Further, another example of the picking system of the present invention is a picking system including: a movable rack that can be moved; an AGV for transporting the movable rack; an AGV area in which the AGV transports the movable rack; a picking station that abuts the AGV area; and a picking location that is located at an accessible distance from the picking station, and in which the transported movable rack is placed. Two or more picking locations are present for one picking station.

### Advantageous Effects of Invention

According to the present invention, it is possible to achieve an effective picking system in such a way that the area in which automated guided vehicles transport racks is separated from the area in which workers perform picking, and that the boundary of the areas is changed according to the amount of goods.

### BRIEF DESCRIPTION OF DRAWINGS

FIG. 1 is a plan view of a warehouse, which shows the outline of Example 1 of the present invention.

FIG. 2 is a diagram showing a configuration of the control of the warehouse.

FIG. 3 is a perspective view of the warehouse using Example 1 of the present invention.

FIG. 4 is a view showing an operation of Example 1 of the present invention.

FIG. 5 is a view showing another operation of Example 1 of the present invention.

FIG. 6 is an example of the product information table.

FIG. 7 is an example of the movable rack information table.

FIG. 8 is an example of the picking location information table.

FIG. 9 is an example of the AGV information table.

FIG. 10 is an example of the control flow.

FIG. 11 is an example of the screen output on a monitor.

FIG. 12 is an example of the display of an electronic bulletin board.

FIG. 13 is a timing chart focusing on the picking location.

FIG. 14A is a plan view of a warehouse, which shows an example of changing the position of the picking line.

FIG. 14B is a plane view of the warehouse, which shows a variation of changing the position of the picking line.

FIG. 15(a) is a view of the warehouse seen from the side to show picking using a high movable rack, FIG. 15(b) is a plan view, and FIG. 15(c) is an example of the information table of the picking location.

FIG. 16(a) is a view of a warehouse seen from the side, showing an example in which the present invention is applied to the mezzanine, and FIG. 16(b) is a plan view.

FIG. 17 is a plan view of a warehouse in which racks in the AGV area are closely arranged.

FIG. 18(a) is a plan view of a picking station which is Example 2 of the present invention, FIG. 18(b) is a diagram showing a control configuration of Example 2, and FIG. 18(c) is a detailed view of a sorting rack.

FIG. 19(a) is an example of the operation of a conventional picking station, and FIG. 19(b) is an example of the operation of Example 2 of the present invention.

FIG. 20(a) is an example of the screen displayed on the monitor shown in FIG. 18, and FIG. 20(b) is an example of the display of the sorting rack.

### DESCRIPTION OF EMBODIMENTS

Hereinafter, embodiments for carrying out the present invention will be described with reference to the accompanying drawings and figures.

### Example 1

### Racks and Vehicles

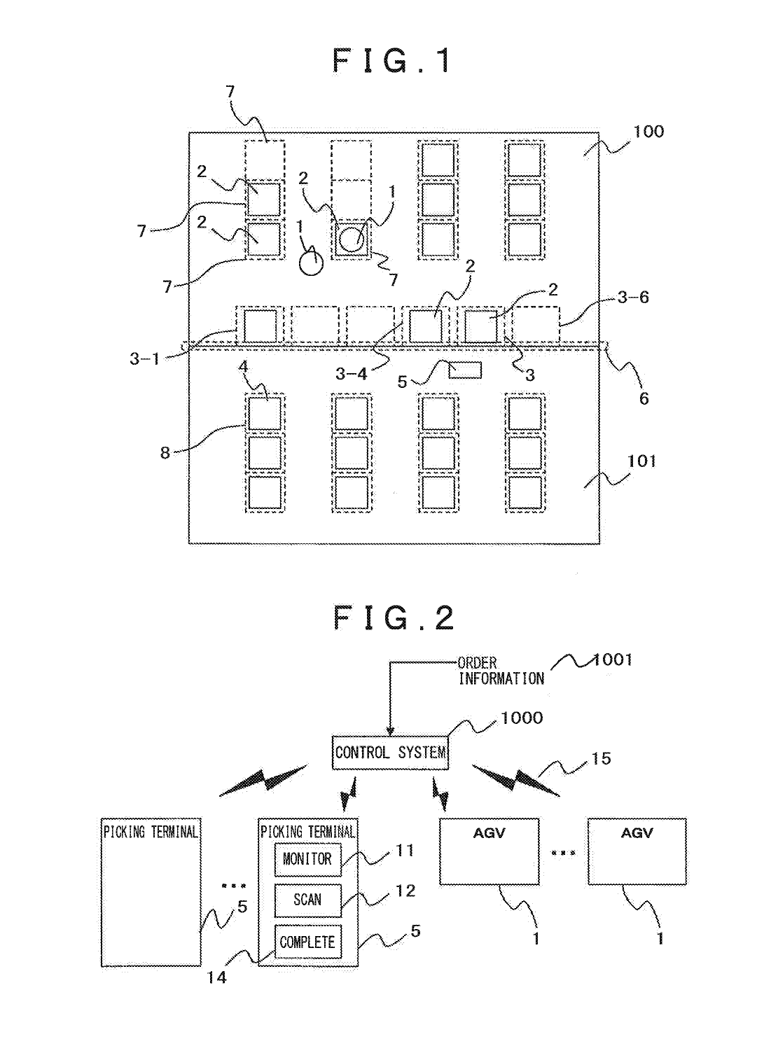

The outline of the present invention will be described with reference to FIG. 1. FIG. 1 is a plan view of a warehouse, including an AGV area 100 in which an automated guided vehicle (hereinafter, AGV) runs, and a picking area 101 in which picking is performed by a worker. The two areas abut each other with a picking line 6 between them.

The AGV area 100 is provided with an AGV 1, a movable rack 2 that can be moved by the AGV 1, a picking location 3, and a movable rack location 7. The movable rack is transported and placed at the picking location 3 by the AGV 1 only when a product or part (hereinafter, simply referred to as “product”) that is stored in the rack is taken (picked). The movable rack is returned to the movable rack location 7 when no product is taken from the movable rack.

Here, “picking” is an operation for taking the product present in the position specified in the fixed rack or movable rack, while “place” refers to making the movable rack available for picking in a predetermined location, or refers to the state in which the movable rack is available for picking. Specific examples of “place” include the following two cases: one is that the AGV 1 transports the movable rack 2 to a predetermined position and lifts down the movable rack 2, then allows the movable rack 2 to stand by itself; and the other case is that the AGV 1 transports the movable rack 2 to a predetermined position and then stands still while holding (lifting up) the movable rack 2.

One or more AGVs 1 (in general, a plurality of AGVs 1), a plurality of movable racks 2, a plurality of picking locations 3, and a plurality of movable rack locations 7 are present. Note that each of the picking location 3 and the movable rack location 7 is the information showing the position in the warehouse, in which actually there may be no particular frame, mark, or other visible indications. In FIG. 1 and other figures, the picking location 3 and the movable location 7 are shown by dotted lines for convenience.

The picking area 101 is provided with a picking terminal 5, a worker (not shown in FIG. 1), a fixed rack 4, and a fixed rack location 8 in which the fixed rack 4 is placed. One or more picking terminals 5, a plurality of fixed racks 4, and a plurality of fixed rack locations 8 are present in the picking area. There is no particular frame or mark in the fixed rack location 8 as in the case of the AGV location 3.

In the picking line 6, the worker on the side of the picking area 101 can take the stored product from the movable rack 2 that is placed at the picking location 3 within the AGV area 100, over the picking line 6.

(Control Configuration of the Warehouse)

FIG. 2 shows a configuration of the control of the warehouse. The control is mainly performed by a control system 1000 which is connected to the picking terminal 5 and the AGV 1 by a wireless network such as a wireless LAN. The control system 1000 has the same configuration as a server, and is provided with a CPU, a memory, an external storage, or other components (not shown).

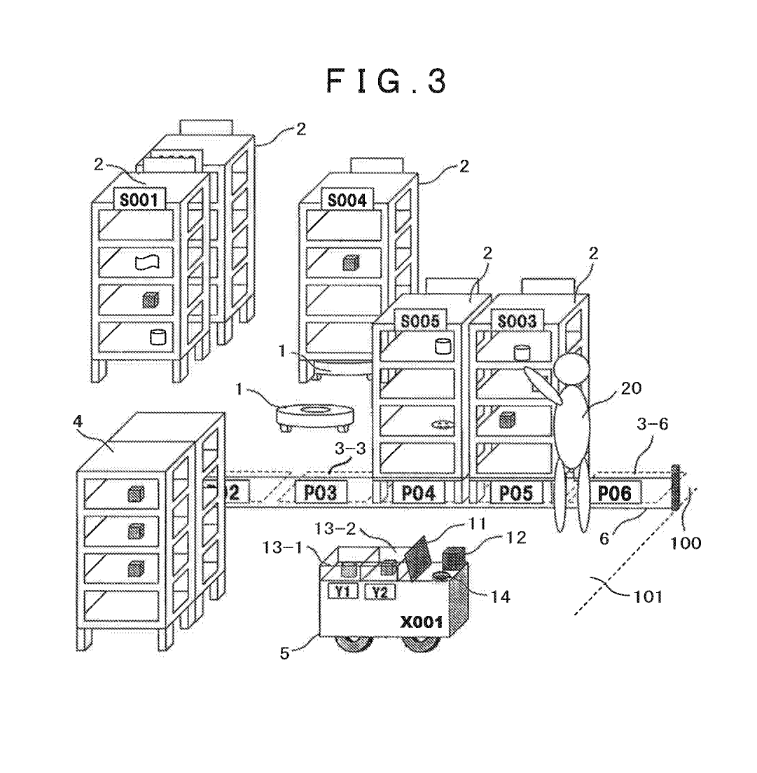

When a necessary product is shipped out, order information 1001 of the product is input to the control system 1000. The control system 1000 puts the order information 1001 of a plurality of products together, and transmits the information of a plurality of products to one picking terminal 5. The information of a plurality of types of products is received by the picking terminal 5, and then the IDs of the products, as well as the positions of the racks in which the products are placed are displayed on a monitor 11 that is provided in the picking terminal 5. The worker determines one product, moves to the position of the rack in which the product is stored, takes the product from the position specified in the rack, reads the barcode of the product by a barcode scanner 12 that is provided in the picking terminal 5, to confirm that the product is the correct one. Then, the worker stores a specified number of products into a bucket (see the bucket 13 in FIG. 3). After storing the required number of products into the bucket, the worker clicks on a completion button 14. In this way, the picking process of one product is completed. The information of the completion of the picking process of one product is given to the control system 1000. The worker repeats this process to complete picking of all the products initially received by the picking terminal 5.

On the other hand, when the intended product is present in a movable rack, the control system 1000 selects one AGV 1, and instructs the AGV 1 to transport the target movable rack 2 to the vacant picking location 3. The instructed AGV 1 transports the movable rack 2 autonomously or on receiving instructions, such as the running route, from the control system 1000. The AGV 1 transports the movable rack 2 to the specified picking location 3. When the disposition of the movable rack 2 is completed, the AGV 1 notifies the control system 1000 of the information about the completion of the disposition.

FIG. 3 is a schematic perspective view of FIG. 1 and FIG. 2. FIG. 3 only shows some of the movable racks 2 and some of the fixed racks 4. Further, the movable rack location 7 and the fixed rack location 8 are not shown in FIG. 3. The picking terminal 5 is a cart-like terminal, in which one or more (two in FIG. 3) buckets 13 are installed to store the picked products. Products picked by a worker 20 are stored in the bucket 13 located in the position specified in the monitor 1. The picking line 6 is a virtual line that indicates the boundary between the AGV area 100 and the picking area 101, in which a fence lower than the bottom step of the movable rack is provided in order to visually indicate the position of the picking location 3 to the worker, or in order to prevent the worker from entering the AGV area by mistake.

### Operation Example

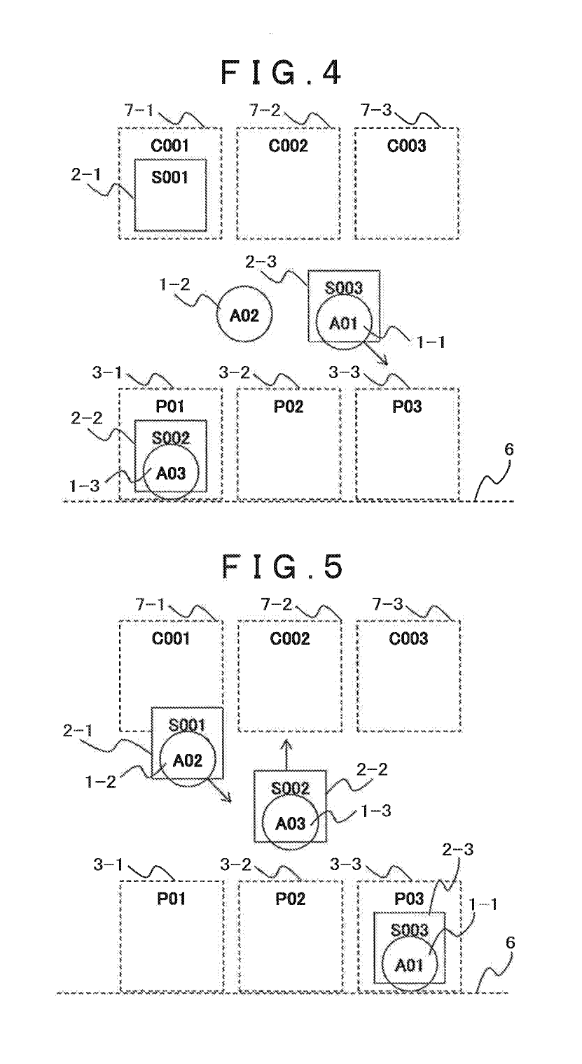

The operation of the present invention will be described with an example in FIG. 4 showing three AGVs 1, three movable racks 2, three picking locations 3, and three movable rack locations 7. The AGV 1, the movable rack 2, the picking location 3, and the movable rack location 7 are assigned to different IDs of A0x, S00x, P0x, and C00x (x is a number of 1, 2, 3, and so on). In FIG. 4, a movable rack 2-1 is placed at a movable rack location 7-1, and a movable rack 2-2 has been picked in a picking location 3-1 and is held (lifted up) by an AGV 1-3, and then a movable rack 2-3 is being transported to a picking location 3-3 by an AGV 1-1. At the next timing, as shown in FIG. 5, the movable rack 2-1 is being transported by an AGV 1-2 to a picking location 3-2 due to an instruction to perform another picking operation instructed, and the movable rack 2-2 is being transported by the AGV 1-3 to a movable rack location 7-2, and then the movable rack 2-3 is placed at a picking location 3-3.

(Data for Control)

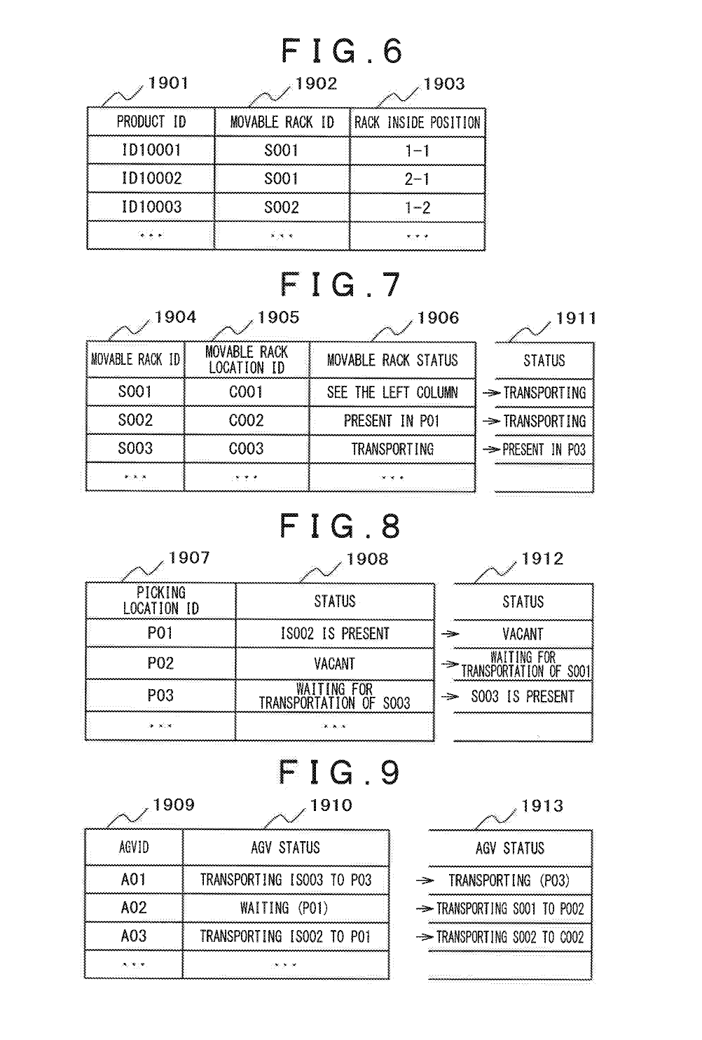

FIGS. 6 to 9 show examples of the data stored in the control system 1000 at the time of FIG. 4. FIG. 6 is a product information table for storing information about which movable rack the product intended to be picked is stored in. By searching for a desired ID in a product ID column 1901, it is possible to obtain a movable rack ID column 1902 in which the product is present, as well as a rack inside position column 1903 of the product in the movable rack. Note that the rack inside position column 1903 of the product describes each data in the following format: the step position of the rack (vertical position)−the horizontal position of the rack.

FIG. 7 is a movable rack information table related to a movable rack 3. By searching for a desired movable rack ID column 1904 from the movable rack ID column, it is possible to obtain the movable rack location ID from a movable rack location ID column 1905 of the movable rack and to obtain the movable rack status from a movable rack status column 1906. The movable rack location ID column 1905 is the position information required when the appropriate movable rack is returned to the movable rack location. The movable rack status is the information related to the current position of the movable rack, which shows whether the movable rack is in the movable rack location 7 or in the picking location 3, or whether the AGV is transporting the movable rack. When the AGV is transporting the movable rack, the appropriate information of the movable rack status column 1906 is updated after the completion of the transportation. Then, the information of the location in which the movable rack is placed can be obtained.

FIG. 8 is a picking location information table related to the picking location 3. By searching for a desired picking location ID in a picking location ID column 1907, it is possible to obtain the status from the status column 1908 corresponding to the desired picking location. The status is the information of the movable rack 2 placed at the picking station. The information shows whether the movable rack is placed, or the movable rack is in a state of waiting for transportation, or the movable rack is not scheduled to be transported yet and is free. The status column 1908 is updated as needed according to the transportation state of the movable rack by the AGV.

FIG. 9 is an AGV information table related to the AGV 1. By searching for a desired AGV ID in an AGV ID column 1909, it is possible to obtain the AGV status from an AGV status column 1910. The AGV status is the operational status of the AGV, which shows whether the AGV is transporting the movable rack (including proceeding to the transportation), or the AGV is in a waiting (vacant) state with no transportation scheduled, or the AGV is being charged, or the AGV is out of service (including a power-off state and a failure state). The AGV status column 1910 is updated as needed according to the change in the operational status of the AGV. Note that in the waiting state, by combining with the information about the waiting position, it is possible to select the AGV near the appropriate movable rack in the assignment of the next task.

FIGS. 7, 8, and 9 show the state of FIG. 4. When the time has elapsed and the state of FIG. 4 changes to the state of FIG. 5, the respective statuses of FIGS. 7, 8, and 9 change to the states shown in the right side of the respective tables. In other words, the respective statuses change to movable rack status 1911, status 1912, and AGV status 1913.

(Control Flow)

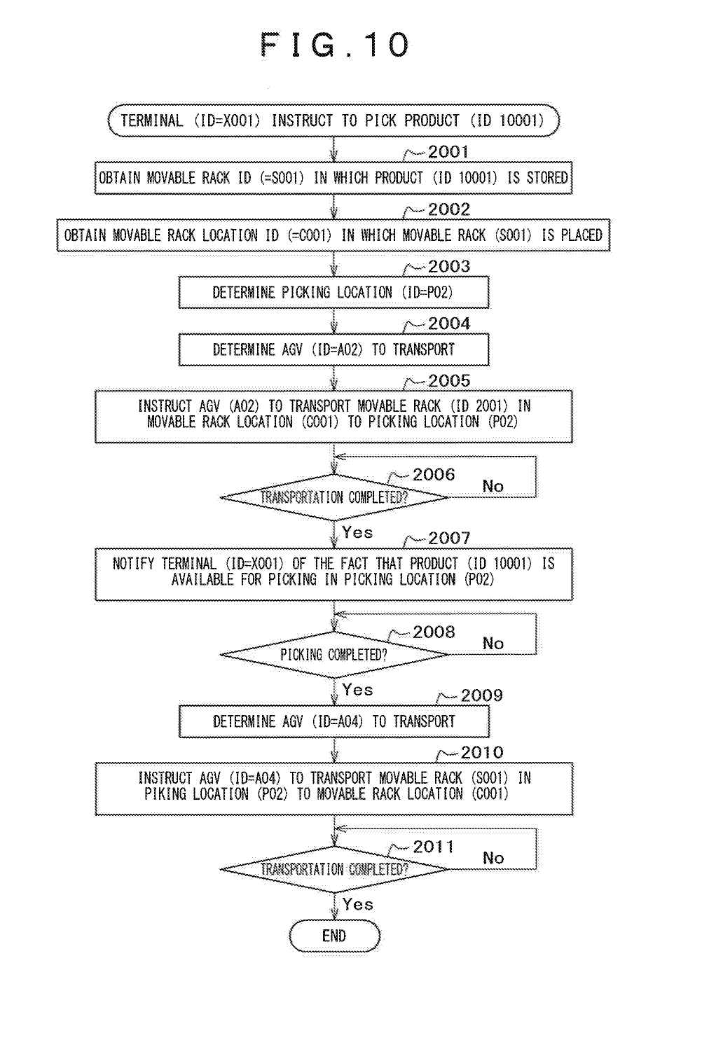

FIG. 10 is a diagram showing the control flow in the control system 1000 when a product (ID=10001) in the movable rack 2-1 (movable rack ID=S001) shown in FIG. 4 is picked by the picking terminal 5 (terminal ID=X001). In the flow, the control system 1000 performs control by referring to the tables shown in FIGS. 6 to 9. The details are described below.

In Step 2001, the control system 1000 obtains the movable rack ID (ID=S001) in which the product (ID=10001) is stored by using the table of FIG. 6. Next, in Step 2002, the control system 1000 reads the movable rack location of the movable rack (ID=S001) and the status by using the table of FIG. 7, and confirms that the movable rack is present in the movable rack location (ID=C001). In Step 2003, the control system 1000 searches for a vacant picking location by using the table of FIG. 8, and reserves the obtained picking location (ID=P02). Further, in Step 2004, the control system 1000 searches for a vacant AGV by using the table of FIG. 9, and reserves the obtained AGV (ID=A02).

After these pieces of information are collected, in Step 2005, the control system 1000 instructs the AGV (ID=A02) to transport the movable rack (ID=S001) present in the movable rack location (ID=C001) to the picking location (ID=P02). In response to this instruction, the AGV (ID=A02) moves from the current position (for example, the position of AGV 1-2) to the movable rack location (ID=C001). Then, after checking the movable rack (ID=S001), the AGV lifts up the movable rack (ID=S001), transports the movable rack (ID=S001) to the picking location (ID=P02), and places (lifts down) the movable rack (ID=S001).

When the disposition is completed, the AGV (ID=A02) notifies the control system 1000 of the completion of the transportation through a wireless network. The control system 1000 receives the notification about the completion of the transportation in Step 2006 and moves to the next Step 2007. Note that, at this time, the state of the AGV (ID=A02) in the table of FIG. 9 is changed to “waiting (location=P02)”.

In Step 2007, the control system 1000 transmits the information that the product (ID=10001) is ready to be picked in the picking location (ID=P02), to the picking terminal (I=X001) the worker is using. At this time, the picking terminal (ID=X001) notifies the worker of the fact that the product (ID=10001) is ready to be picked. In addition to this notification, the picking terminal (ID=X001) displays the movable rack ID (ID=S001) in which the product is stored to the worker. Thus, the worker can perform picking after visually checking the ID of the movable rack in the picking location, so that it is possible to prevent picking errors.

The picking worker picks a predetermined product, and reads the barcode of the product by the barcode scanner 12 to check that the information of the read barcode is correct. Note that if the picking worker notifies the control system 1000 of the information that the barcode is read, the control system 1000 can recognize that the worker starts picking the product (ID=10001) (which is not shown in FIG. 10). In this way, the system 1000 can effectively manage the picking location 3 by means of predicting the picking end time of the appropriate movable rack, or by other methods.

When the operation is completed, the worker clicks on a completion button 14 shown in FIG. 2 or FIG. 3. The completion information is given to the control system 1000, which is combined with the barcode information of the product that has been given in advance. In this way, the control system 1000 to recognizes, in Step 2008, that the picking operation of the product (ID=10001) in the picking location (ID=P02) has been completed, and then moves to the next Step 2009.

In Step 2009, the control system 1000 searches for a waiting AGV by using the table of FIG. 9 in order to remove the movable rack (ID=S001) in the picking location (ID=P02). Step 2009 in FIG. 10 shows an example in which a new fourth AGV (ID=A04) is reserved because it is in the waiting state. If the AGV (ID=A02) that is specified in Step 2005 is still present in the picking location (ID=P02), the waiting time for AGV arrival is shorter when the control system 1000 reserves the AGV (ID=A02) in place of the AGV (ID=A04).

In Step 2010, the control system 1000 instructs the AGV (ID=A04) to transport the movable rack (ID=S001) present in the picking location (ID=P02) to the movable rack location (ID=C001). In Step 2011, the control system 1000 confirms that the transportation of the movable rack (ID=S001) to the movable rack location (ID=C001) is completed. Then, the control system 1000 completes the process of picking the product (ID=10001) present in the movable rack 2-1 (movable rack ID=S001) through the picking terminal 5 (terminal ID=X001).

The above description shows only the process of picking one product by one picking terminal 5. However, in the actual system, the process shown in FIG. 10 is processed in multi-tasking. In other words, this corresponds to the case in which a movable rack transportation for a certain picking terminal and a movable rack transportation for another picking terminal are performed at the same time, or a first movable rack transportation for a certain picking terminal and a second movable rack transportation for the same picking terminal are performed at the same time, or the combination of the two. Also in multi-tasking, each of the managements, such as the management of the AGV 1 and the management of the picking location, is performed in one table of FIG. 8 or FIG. 9. For this reason, there is no possibility of providing two or more instructions to one AGV, or providing an instruction that two or more movable racks are placed at one picking location. By performing such a multi-task process, it is possible to reduce the time until picking is available in each picking terminal.

The above description shows the process in which the movable rack in which the picking has been completed is returned to the original movable rack location. However, during picking in the movable rack by the first picking terminal, if the other second picking terminal is instructed to pick the product present in the same movable rack, the first picking terminal notifies the second picking terminal of the fact that picking is available at the time of the completion of the picking by the first picking terminal is completed. In this way, it is possible to reduce the waiting time until picking is available for the second picking terminal. In addition, this makes it possible to omit the process that is required for the AGV to once return the movable rack to the movable rack location and transport again to the picking location. As a result, the efficiency of the use of the AGV is increased, so that the efficiency of the whole picking system is increased. Such a control can be achieved by the following steps. In Step 2002 in FIG. 10, when the appropriate movable rack is already present in a certain picking location at the time of checking the status of the movable rack, the information that allows the movable rack to remain placed at the same picking location also after the completion of the picking of the movable rack is held within the control system 1000. Then, if there is information that allows the movable rack to remain placed at the same picking location in Step 2009 in FIG. 10, the control system 1000 does not perform the process after Step 2009.

(Monitor)

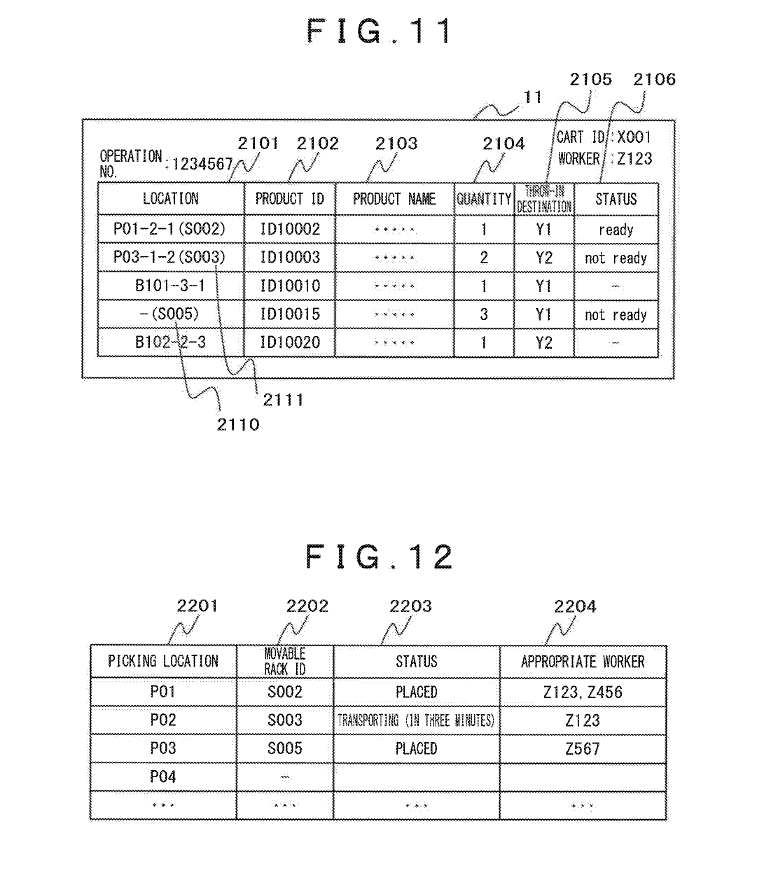

FIG. 11 is an example of the screen output to the monitor 11 that is attached to the picking terminal 5. The screen is provided with columns of location 2101, product ID 2102, product name 2103, quantity 2104, throw-in destination 2105, and status 2106. The information of the product to be picked is described in each line. For example, in the case of the first line, one product of product ID 10002 that is present in location P01-2-1 (S002), namely, in the first of the second step of the movable rack S002 in the picking location P01, is taken and thrown in a bucket Y1 (the bucket 13-1 in FIG. 3) of the picking terminal. The column of the status 2106 shows whether or not the appropriate movable rack is placed at the specified picking location. In the example in FIG. 11, the movable rack (S002) of the first line is placed at the picking location P01 (“ready”). However, the movable rack (S003) of the second line is not placed yet (“not ready”). In other words, the movable rack is being transported or is prepared to be transported. The worker checks the status column 2106, and goes to the movable rack that is in a state of being placed (“ready”) to perform picking.

With respect to the display of the status column 2106, when the state is before Step 2006 in the flow of FIG. 10, the flow of FIG. 10 displays “not ready”. Then, at the time when the transportation is completed and the flow moves to Step 2007, “ready” is displayed. When “not ready” is displayed and when the state is before Step 2003 in the flow of FIG. 10, the picking location ID is not displayed and only the movable rack ID is displayed such as in the location 2110 as shown in the line of ID10015 for the product ID column 2102 of FIG. 11. On the other hand, in the state from Step 2003 to Step 2006, both the picking location and the movable rack ID are described as exampled in the location 2111 of FIG. 11. The screen of FIG. 11 is updated as needed. The status of the fixed rack is not displayed.

The notification of whether or not the appropriate movable rack is placed at the specified picking location is not only displayed on the screen as shown in an example in FIG. 11, but can be given with a blinking of the screen or sound and vibration at the time when the display is changed to “ready”. Ensuring the notification of the change in the status to the worker can prevent missing of status change due to carelessness or negligence of the worker. Thus, the picking efficiency can be increased (the picking operation time can be reduced).

Further, the present invention also includes displaying the estimated amount of time required to complete the disposition of the movable rack, or the scheduled time for disposition of the movable rack into the column of the status. By obtaining the position information of the current AGV (movable rack) in addition to the information of whether or not the transmission is completed in Step 2006 of FIG. 10, the time when the transportation will be completed can be estimated from the information of the distance between the current position and the intended picking location as well as the speed of the AGV, or other information. In this way, by notifying the worker of the estimated amount of time required or the scheduled time for disposition before the movable rack is placed at the picking location, the worker can make a plan for the rounds on the racks effectively, so that the efficiency of picking can be improved. The screen of the monitor 11 may display the positions of the products and movable racks graphically, in addition to using text as shown in FIG. 11.

(Electronic Bulletin Board)

Further, the present invention also includes electrically displaying the information of whether or not the appropriate movable rack is placed at the picking location in the vicinity of the picking line (“electronic bulletin board”). FIG. 12 shows an example of the electronic bulletin board. The electronic bulletin board is displayed on a large display or an electronic display board. As shown in FIG. 12, the electronic bulletin board is provided with the columns of picking location 2201, movable rack ID 2202, status 2203, and appropriate worker 2204. All the picking locations are displayed in the picking location column 2201. In each picking location, which movable rack is placed, or which movable rack is scheduled to be placed is displayed in the movable rack ID column 2202 and the status column 2203. In the appropriate worker column 2204, the ID of the worker who performs picking from the displayed movable rack is displayed. The example in FIG. 12 shows that the movable racks have been already placed at the locations of P01 and P03, but there is no movable rack in P02 because the movable rack is being transported, and then there is no schedule for disposition of the rack in P04.

The worker checks the electronic bulletin board to ensure that the specified movable rack is placed at the picking location in which the worker must perform picking. Then, the worker performs the picking operation when the movable rack is placed at the location. The example of FIG. 12 shows that a movable rack (ID=C003) is placed in three minutes at the location of P02. Thus, the worker can make a plan to go to the picking location in line with this time. In this way, by electronically displaying the information in the vicinity of the picking line, it is possible to reduce the amount of communications between the control system and the picking terminal 5 shown in FIG. 2. Further, the electronic bulletin board allows the administrator of the operation to understand in an integral way with the operational status of each picking location. Furthermore, the appropriate worker column 2204 allows the administrator to warn the worker who missed checking that the movable rack has arrived or the worker who missed the information, in order to prevent the reduction in the operational efficiency. The display on the electronic bulletin board and the display to the picking cart 5 of FIG. 11 can be performed at the same time. Such a simultaneous display can increase the number of means for the worker to check the disposition state of the movable rack, resulting in an increase in convenience. At the same time, the efficiency of the operation can be improved or the reduction in the operational efficiency can be prevented. There may be a plurality of electronic bulletin boards. The more the number of electronic bulletin boards, the more the number of opportunities the worker can check the information, and it is effective in preventing the worker from missing the information.

(Timing Chart)

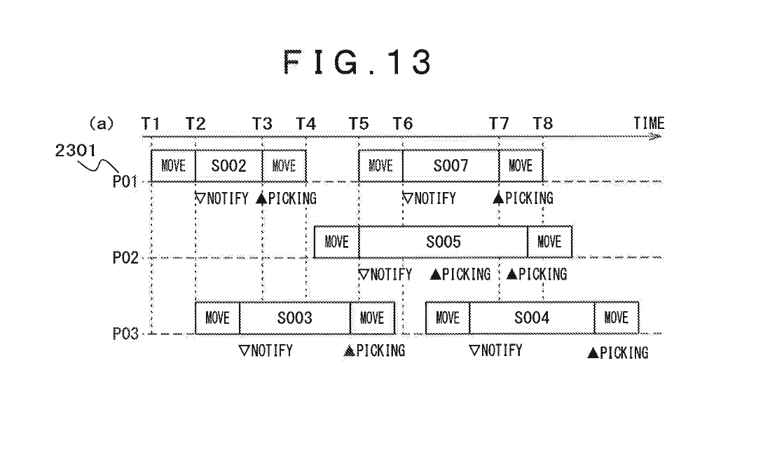

FIG. 13 is an example of the operation of the present invention, using a timing chart that focuses on each of the picking locations. The description focuses on the picking location P01 (2301). The AGV that has transported the movable rack S002 arrives at time T1, and the disposition of the movable rack S002 is completed at time T2. At time T2, the picking terminal of the worker who performs picking is notified of the fact that the movable rack S002 is placed. The worker who received the notice goes to the picking location P01, takes the specified product from the movable rack S001, and completes the picking at time T3. When the picking is completed, the movable rack S001 is moved (removed) from the picking location P01 by the AGV, and then the picking location P01 is in the state in which there is no moving rack. After that, in response to an instruction from the control system, the movement of a moving rack S007 is started at time T5 and is completed at time T6. As in the case described above, the picking is completed at time T7, and the movable rack S007 is moved (removed) at time T8. In the picking locations P02 and P03, the respective movable racks are moved (transported) independently, and they are moved (removed) after the picking is completed. Note that a movable rack S005 is picked twice in the picking location P02 in FIG. 13, which shows that different workers perform picking from the same movable rack S005. The ability to control the whole picking system so that a plurality of workers perform picking from the movable rack that is once placed as described above, will increase the entire picking efficiency.

(Filling Up)

While the above description focuses on the process of picking, the present invention is also applicable to the filling up process for the rack. The filing up process can be achieved by replacing the operation of “taking the product from the rack” in the above description with “storing in the rack”. Further, the present invention also includes performing, for example, in the configuration of FIG. 1, the picking process and the filling up process at the same time in parallel. In other words, at a certain point of time, the filling up operation is performed in the picking location 3-1 while the picking operation is performed in another picking location. Such a parallel operation can eliminate the need to interrupt the picking operation to perform the filling up operation, and the lack of inventory does not occur in the movable racks. As a result, the picking operation can be performed permanently.

(Selection of the Picking Location)

In the above description, there is no particular mention of which picking location 3 a certain movable rack 2 should be placed at. With respect to the selection method of the picking location, the location may be selected in the order of the ranking in the table of FIG. 8 (vacant location on the top of the table) or may be selected at random. However, a new effect occurs by the following variation.

An example of the selection method of the picking location is to select the picking location close to the position in which the worker is currently present, based on the position information of the worker who performs picking from the appropriate movable rack. The position information of the worker can be obtained from the position in which the product picked by the worker is present, the position measured through a wireless LAN, the position measured according to the presence or absence of near-field wireless reception, the position measured according to the presence or absence of infrared beacon reception, the analysis of the image of the camera located in the warehouse, or other information. In this case, the worker may move during the time from when the picking location is determined until the AGV transports the movable rack to the picking location. It is also possible to determine the picking location by estimating the position of the worker at the time when the AGV transports the movable rack to the picking location, from the position of the worker at the time when the picking location is determined and from the position of the remaining picking operation of the worker. Further, by adding the information of the orientation of the worker, it is possible to estimate more detailed position information. The orientation of the worker can be obtained by the following methods: estimating from the position of the rack from which picking has been performed, measuring using an electronic compass provided in the picking terminal, estimating from the acceleration information by an electronic gyroscope, and analyzing the image of the camera located in the warehouse. In any of the methods, the movement of the worker is reduced to reduce the picking time by disposing the movable rack to the picking location close to the worker. As a result, the picking efficiency can be improved.

A second selection method of the picking location is to categorize the products and determine the picking location for each category. For example, in FIG. 1, when it is determined that the picking locations 3-1 to 3-3 are for stationery and the picking locations 3-4 to 3-6 are for clothing, the worker can estimate the rough position of the picking location from the product name to be picked. Thus, the worker can perform picking by taking an efficient route.

In the selection of the picking location, it is also possible to put a limit so that products with a similar shape are not lined up. If products with a similar shape are stored close to each other (for example, in the left end of a certain movable rack and the right end in the same step of the movable rack that is on the left side of the first one), the worker might take a wrong product in the picking. Even if the worker has taken a wrong product, wrong delivery or other problems may be prevented as long as the error is detected by the barcode scanner. However, this could lead to a time loss due to the act of retaking the product, or lead to an error due to the act of returning the product to the incorrect position (when the worker returns the wrong product to the position of the proper product that the worker should take). When products with a similar shape are lined up, it is possible to prevent such a time loss and product return error by changing the position of the picking location.

As a selection method of the picking location, the present invention also includes a combination of the picking location selection methods described above. For example, the probability that the similar products are close to each other is high when the picking location is determined for each category. Thus, the selection method is combined with a restriction that the products with a similar shape will not be lined up, in order to prevent the number of picking errors from increasing. In this way, it is possible to increase the efficiency.

(Picking Line Change)

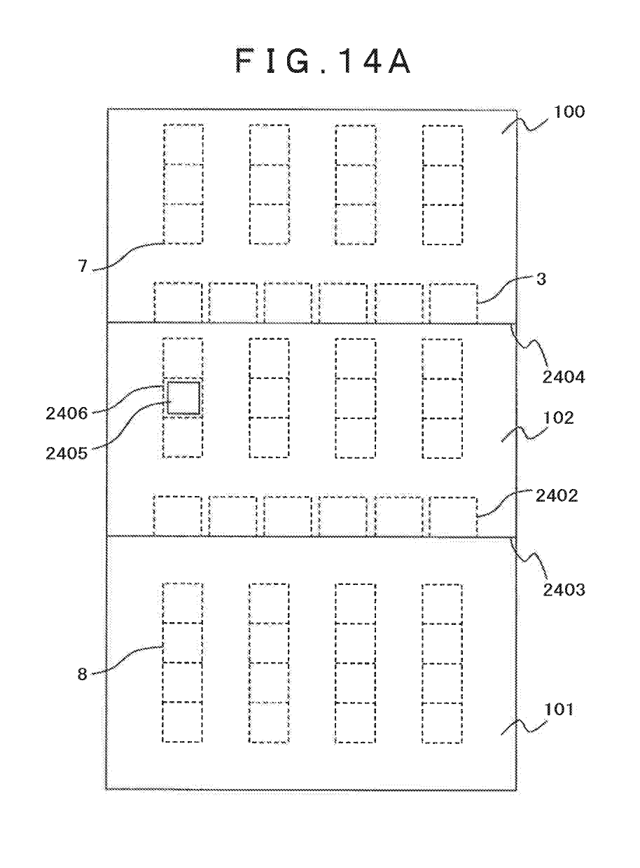

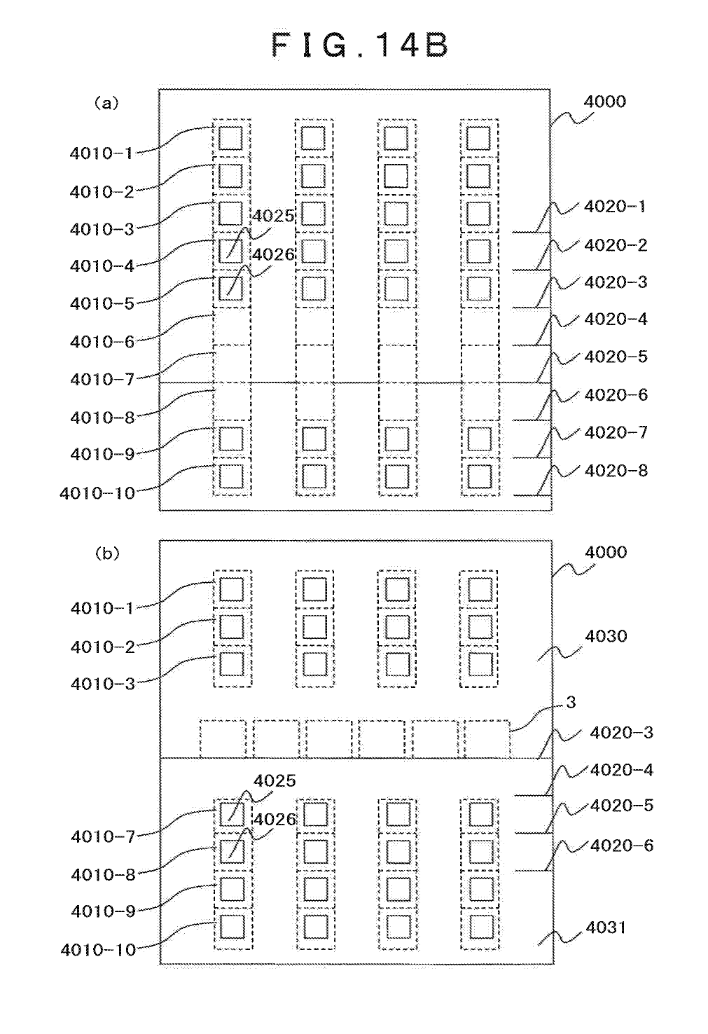

FIG. 14A is an example of changing the position of the picking line 6 in FIG. 1 according to a first embodiment. FIG. 14A is a plan view of the warehouse, in which a switching area 102 is provided between the AGV area 100 and the picking area 101 in FIG. 1. The switching area 102 is the area capable of switching between the function of the AGV area and the function of the picking area according to the setting. In the switching area 102, as in the case of the AGV area, there are a movable rack location 2406, a picking location 2402, and a boundary 2403 between the switching area 102 and the picking area 101. The operation has the following modes: “picking mode” in which the AGV 1 runs only inside the AGV area 100 and the worker performs picking in the switching area 102 and the picking area 101; and “AGV mode” in which the AGV 1 runs inside the AGV area 100 and the switching area 102 while the worker performs picking only in the picking area 101.

In the picking mode, a movable rack 2405 is placed at the movable rack location 2406 of the switching area 102. However, the movable rack 2405 is not moved to the other movable rack location and used as the fixed rack. There is no movable rack placed at the picking location 2402. The picking location 2402 is used as the aisle. The picking line becomes a boundary 2404, so the boundary 2403 does not serve any function.

On the other hand, in the AGV mode, the function of the picking location 3 is moved to the picking location 2402, and the picking line is also moved to the boundary 2403. The picking location, at which no movable rack is placed, is used as the aisle. In other words, the AGV 1 runs in the combined area of the AGV area 100 and the switching area 102, and transports the rack to be picked to the position of the picking location 2402. The worker takes the product of the movable rack that is placed at the picking location 2402, from the side of the picking area 101 of the boundary 2403. Note that the boundary 2404 does not serve any function at this time.

(Switching of the Mode)

The control system 1000 of FIG. 2 has a flag to store the current mode, whether AGV mode or picking mode. Based on the flag, the control system 1000 switches whether or not the movable rack in the switching area is transported by the AGV, or whether the picking location is the position of the picking location 3 or the position of 2402. The switching of the mode is performed by the following procedure.

From the AGV mode to the picking mode

(A1) Interrupt the normal rack transportation operation of the AGV.

(A2) Return the movable rack present in the picking location 2402 to the original movable rack location. In other words, an instruction is given to the AGV 1 to transport the movable rack.

(A3) Move all the AGVs to the AGV area 100.

(A4) Check all the locations of the racks of the products that have not been picked, and notify the worker if there is a change (change from the picking location 2402 to the movable rack location 2401, change from the picking location 2402 to the picking location 3) (Update the screen information in FIG. 11).

(A5) Switch the mode and start the rack transportation operation of the AGV.

From the Picking Mode to the AGV Mode

(B1) End the picking operation in the switching area and move the worker in the switching area to the picking area.

(B2) After confirming that there is no worker in the switching area, instruct the control system to prepare switching (the administrator or other authorized person instructs on the operation screen).

(B3) Allow the AGV to move the movable rack from which picking has not been completed with respect to the movable racks in the picking location 3, to the picking location 2402.

(B4) Allow the AGV to move the movable rack from which picking has been completed with respect to the movable racks in the picking location 3, to the original movable rack location.

(B5) Check all the locations of the product racks from which the picking operation has not been completed, and notify the worker if there is a change (change from the movable rack location 2401 to the picking location 2402, change from the picking location 3 to the picking location 2402) (Update the screen information in FIG. 11).

(B6) Switch the Mode and Start the Rack Transportation Operation of the AGV.

Which mode to use is selected in the following manner. In general, the operation mode is switched to the AGV mode to perform the operation with a small number of workers. The workers perform picking in the area that is smaller than the area in the picking mode, so that the picking efficiency per worker is increased.

When the amount of goods is large, the operation mode is switched to the picking mode to perform the operation with a large number of workers. In the picking mode, the same number of AGVs as those in the AGV mode perform the transportation operation in the small area (the AGV area 100), so that the transportation time of each movable rack is reduced and the number of transportations performed is increased. As a result, the waiting time for the transportation of the movable rack can be reduced. Because of these results, the number of movable racks that can be picked in a unit time is increased, so that the system can handle the increase in the amount of goods without increasing the number of AGVs.

Note that when a plurality of switching areas 102 are prepared and when a part of the switching areas is switched to the AGV area according to the amount of goods, it is possible to gradually switch the ratio between the AGV area and the picking area. This makes it possible to achieve a more efficient operation according to the amount of goods.

(Variation of the Picking Line Change)

FIG. 14B is another example of changing the position of the picking line 6 in FIG. 1 according to the first embodiment. FIG. 14B(a) is a plan view 4000 of a warehouse. All the racks are movable racks. The movable racks are placed, except in three lines of the lines from the line of location 4010-1 (four locations in the same horizontal position as the location 4010-1 in FIG. 14B) to the line of the location 4010-10. It is possible to set the picking line per unit of width of the rack in the range of candidate positions from 4020-1 to 4020-8. In FIG. 14B(a), a candidate position 4020-5 is the picking line. The picking location is present in each of the candidate positions 4020-1 to 4020-8 of the respective picking lines, which, however, is omitted in FIG. 14B.

When the position of the picking line is changed, for example, when the picking line is changed from the candidate position 4020-5 to 4020-3, the control system issues an instruction to the AGV to move the movable racks in the line of the location 4010-4 and in the line of the location 4010-5, to the line of the location 4010-7 and to the line of the location 4010-8. More specifically, the control system allows the AGV to move a movable rack 4025 present in the location 4010-4 in FIG. 14B(a) to the location 4010-7 in FIG. 14B(b), and to move a movable rack 4026 present in the location 4010-5 in FIG. 14B(a) to the location 4010-8 in FIG. 14B(b). Further, the appropriate movable racks in the three lines on the right side of the rows (the racks in the vertical direction in the figure) described above, to the line of the location 4010-7 and to the line of the location 4010-8, respectively. After the completion of the movement of the racks, the control system sets the picking line to 4020-3, and sets the picking location to the position of FIG. 14B(b). After the picking line is changed to 4020-3 as described above, the warehouse 4000 of FIG. 14B(b) has three lines from the line of the location 4010-1 to the line of 4010-3, namely, 3×4=12 racks in the AGV area 4030, and four lines from the line of the location 4010-7 to 4010-10, namely, 16 racks in the picking area 4031, thus having 16 racks in total. The racks in the picking area 4031 are the racks that can physically be moved, however, they are treated as fixed racks during the picking operation.

In this way, changing the position of the picking line per unit of width of the rack is an effective way to allow more precise setting of the ratio between the AGV area and the picking area. In addition, as compared to the method of allocating the candidate position of the picking location in advance as shown in FIG. 14A, a large number of racks can be placed in a predetermined area, so that the storage efficiency of the warehouse is increased.

Further, the switching area 102 in FIG. 14A, or the combined area of the AGV area 100 and the switching area 102, or the combined area of the picking area 101 and the switching area 102 can be replaced by the area 4000 shown in FIG. 14B. In such a case, the range in which the picking line can be set is reduced. However, by providing an area as a dedicated picking area, it is possible to place the fixed rack that is better than the movable rack in terms of storage efficiency, or picking efficiency, or filling up efficiency.

Thus, it is possible to increase the picking efficiency of the whole warehouse. Further, by providing an area as a dedicated AGV area, it is possible to prevent defacement or damage to the marker (defacement or damage caused by the worker stepping on the marker) for detecting the self-location of the AGV. In this way, it is possible to operate the AGV stably and efficiently.

(Picking Line Display)

The present invention also includes a function for displaying where the picking line is currently present. The method of showing the picking line includes a method of providing a movable fence that is lower than the bottom step of the movable rack, and a method of showing the position of the picking line by light-emitting materials embedded into the floor surface in the position of the picking line.

In the case of providing a movable fence, in order to prevent that the fence is provided in a position different from the position of the picking line that is set in the control system 1000, it is necessary to detect the position in which the fence is provided by a sensor, transmit the position information of the fence, according to the result of the detection, to the control system 1000. Then, the control system 1000 checks whether or not the position of the picking line on the system is identical to the position of the picking line detected by the sensor. When the positions are different, the control system 1000 issues an alert on the operation screen or other display device, and at the same time, stops the AGV from running or does not instruct the AGV to run. Further, another method of detecting the position of the fence is that, instead of using the sensor, the worker who built the fence clicks on a button corresponding to the position of the picking line to notify the control system 1000 of the position of the picking line. Or, it is also possible that the AGV runs at a low speed to check the position of the fence by itself and notifies the control system 1000 of the position of the fence. By building the fence in the correct position, it is possible to prevent that the worker enters by mistake into the area in which the AGV is running and that the worker comes into contact with the AGV or disturbs the operation of the AGV.

(Stand)

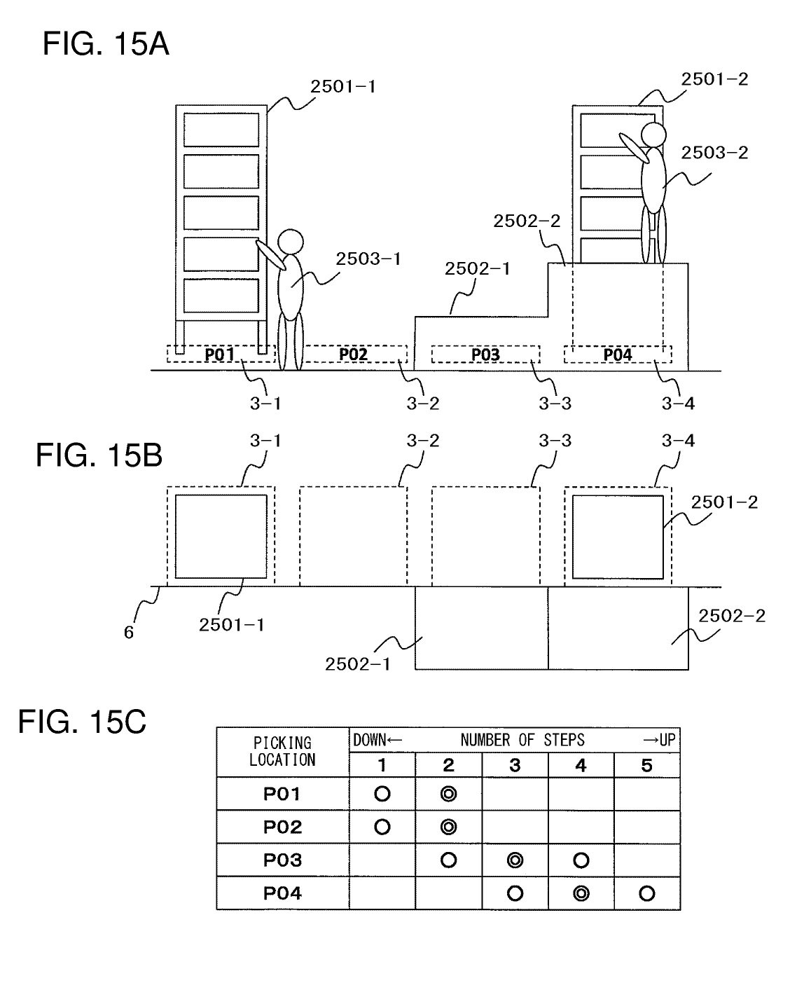

FIG. 15 is a variation of the present invention, showing a method of picking using a rack higher than the range that the worker can reach. FIG. 15(a) is a schematic view of the warehouse seen from the side, and FIG. 15 (b) is a plan view of the warehouse. Products are stored in a high movable rack 2501 also in a position higher than the operation range of the worker. A stand 2502 is placed in front of a part of the picking location 3. In the figure, the stand 2502 has a part 2502-1 and a part 2502-2 with different heights. When the product is stored in the lower part of the high movable rack 2501 to be transported, the control system 1000 (FIG. 2) allows the high movable rack 2501 to be placed at the picking location in which the stand 2502 is not present (in the case of the high movable rack 2501-1 in the figure, the picking location 3-1). Then, the product is taken from the rack. On the other hand, when the product is stored in the upper step of the high movable rack 2501, the control system 1000 allows the high movable rack 2501 to be placed at the picking location in which the stand 2502 of an appropriate height is present (in the example in FIG. 15, the picking location 3-4). A worker 2503-2 climbs on the stand and takes the product from the upper step of the high movable rack 2501-2.

In which picking location and what height of step the product can be taken from are determined using the table of FIG. 15(c). In FIG. 15(c), a field with a circle shows that the product can be taken, and a field with a double circle shows that the product can be taken and the load on the worker is small. The control system 1000 holds, as shown in FIG. 15(c), the information of the position of the rack from which the product can be taken in each picking location 3. Then, based on the information of FIG. 15(c), the control system 1000 determines the position of the picking location according to the position of the step of the rack in which the product is stored in the high movable rack 2501. Note that the control system 1000 modifies the information in consideration of the body height of the worker. In other words, the present invention also includes modifying the information in such a way that, in the case of a tall worker, the product can be picked from the first to third steps also in P01, P02 with no stand provided. As describe above, the storage efficiency of the product (the number of products stored per unit area) can be improved by using the high movable rack. Further, if the high movable rack is used in the conventional picking method, it is necessary for the worker to prepare, carry, and set a movable stand and then remove the movable stand after picking. As a result, the operation efficiency is reduced. In addition, if the stand has not been correctly set, the worker might fall down. On the other hand, according to the present invention, it is possible to substantially reduce the disadvantages described above, the reduction in the efficiency as well as the risk of falling down. Further, as shown in the field with a double circle in FIG. 15(c), by setting the picking location in such a way that the worker does not take the product from a position lower than the waist or from a position higher than the shoulders, it is possible to reduce the load on the worker and expect better operation efficiency. In the present invention, it is shown that the stand 2502 has two types of height. However, the stand 2502 may has one type of height or three or more types of height. Further, in the present invention, it is shown that the stand has a step-like shape, but may have a gradual slope. Fine adjustment of height is possible with the gradual slope shape. The position, height, and range (width) of the stand 2502 can be freely changed. For example, according to the state of the products of the day, when there is no shipping of products stored in a high position, the stand 2502 is removed, while when the amount of shipping of products stored in a relatively high position is large, a large number of low steps 2502-1 are installed. In this way, it is possible to use the picking location more effectively. At this time, the information of FIG. 15(c) is updated according to the height and position of the stand to be installed.

(Mezzanine)

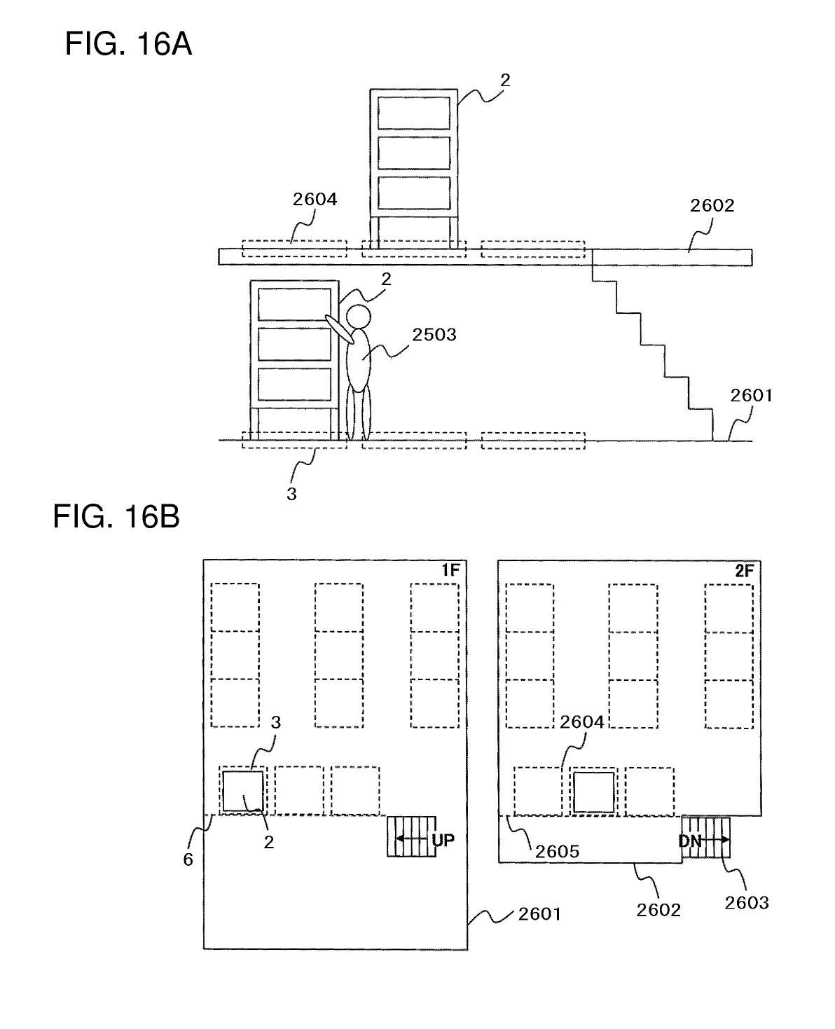

FIG. 16 is an example of installing a mezzanine in the warehouse. FIG. 16(a) is a schematic view of the warehouse seen from the side, and FIG. 16(b) is a plan view of the warehouse. A floor 2601 is the first floor, and a floor 2602 is a mezzanine. The first floor and the mezzanine are connected by a stairway 2603. The movable rack 2 of the first floor is placed at the picking location 3 of the first floor, and is picked over the picking line 6. The movable rack of the mezzanine is built in a picking location 2604 of the mezzanine, and is picked over a picking line 2605. The worker performs normal picking when the location in which the rack from which to pick is placed is on the first floor. While when the picking location is on the mezzanine, the worker puts the picking terminal 5 down, climbs the mezzanine by foot, and performs picking. By installing the mezzanine, it is possible to increase the storage efficiency of the product. In addition, by combining the stand 2502 of FIG. 15 with FIG. 16, the worker can pick the product of the movable rack placed at the picking location 2604 of the mezzanine without climbing the stairway to the mezzanine.

(Variation)

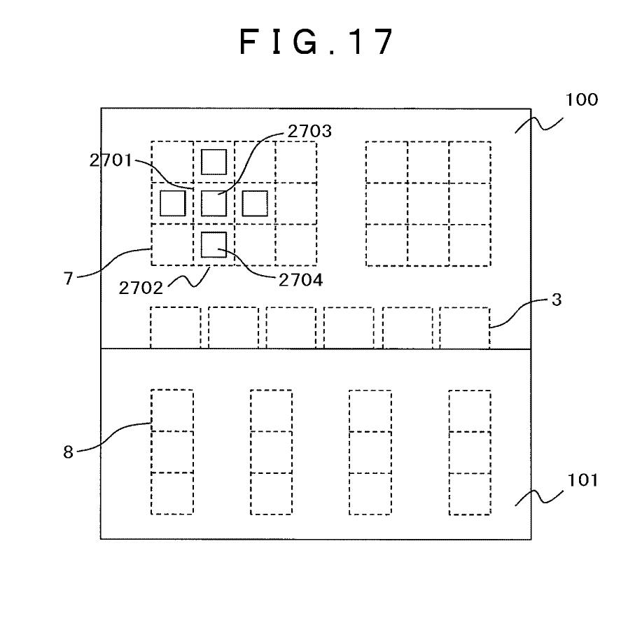

FIG. 17 is another variation of the present invention. In FIG. 17, the movable rack locations 7 are closely arranged in the AGV area 100. For example, a movable rack 2703 in a movable rack location 2701 may not normally be picked by the worker because movable locations are present all around the movable rack 2703. However, by using the AGV, for example, it is possible to move a movable rack 2704 placed at a movable location 2702 to another location, and transport the movable rack 2703 through the vacant movable rack location 2702. In this way, by closely arranging the racks in the AGV area, it is possible to increase the storage efficiency of the AGV area.

With respect to the embodiments described above, the present invention also includes the following variation.

The above description is an example of picking a product in the movable rack 2 in such a way that, after the worker starts the picking operation, the picking location 3 of the movable rack 2 is determined and is notified to the worker. However, it may also be possible to determine the location in which to pick before the worker starts picking. In this case, the columns 2101 to 2105 of the monitor screen shown in FIG. 11 are not changed during the picking operation, so that they are printed on paper and the information of the status is displayed on the electronic bulletin board or other display device. In this way, it is possible to omit the monitor display and thus to reduce the cost of the picking terminal.

A handy terminal with the barcode scanner function can be used as the picking terminal. In this case, the amount of information that can be displayed is limited on the screen of the handy terminal, so it is effective in combination with the method of omitting the monitor screen as described above.

It may not be necessary that the picking line 6 and the picking location 3 abut each other. There may be a space between the picking line 6 and the picking location 3 as long as the movable rack 2, which is placed at the picking location 3, can be accessed (the product can be taken) from the side of the picking area 101. In general, this distance is about several centimeters to fifty centimeters. It is difficult to access to the movable rack if the distance is more than this value.

Although the description assumes that the picking line 6 is linear, the picking line can be a broken line. When a comb-shaped broken line is used for the picking line, the length of the picking line is increased, so that a large number of picking locations can be allocated and the efficiency of the picking can be improved.

The above description is an example that the completion button 14 is mounted in the picking terminal 5. However, it is also possible to provide a completion button corresponding to each picking location 3 in the vicinity of the picking location 3. When the number of picking terminals 5 is greater than the number of picking locations 3, the number of completion buttons can be reduced and cost reduction can be achieved. Further, when the handy scanner is used in place of the cart-like picking terminal 5 shown in FIG. 3, clicking on the completion button 14 can be replaced by reading the barcode that is unique to the movable rack and is attached on the movable rack. With the method of reading the barcode that is unique to the movable rack by the handy scanner, it is possible to eliminate the completion button 14. At the same time, the method is effective in preventing the reduction in the usability when the completion button is mounted on the handy scanner, in which the size of the completion button 14 is reduced and the completion button 14 is difficult to click on, or it is effective in preventing wrong click from occurring.

### Example 2

### Picking Station

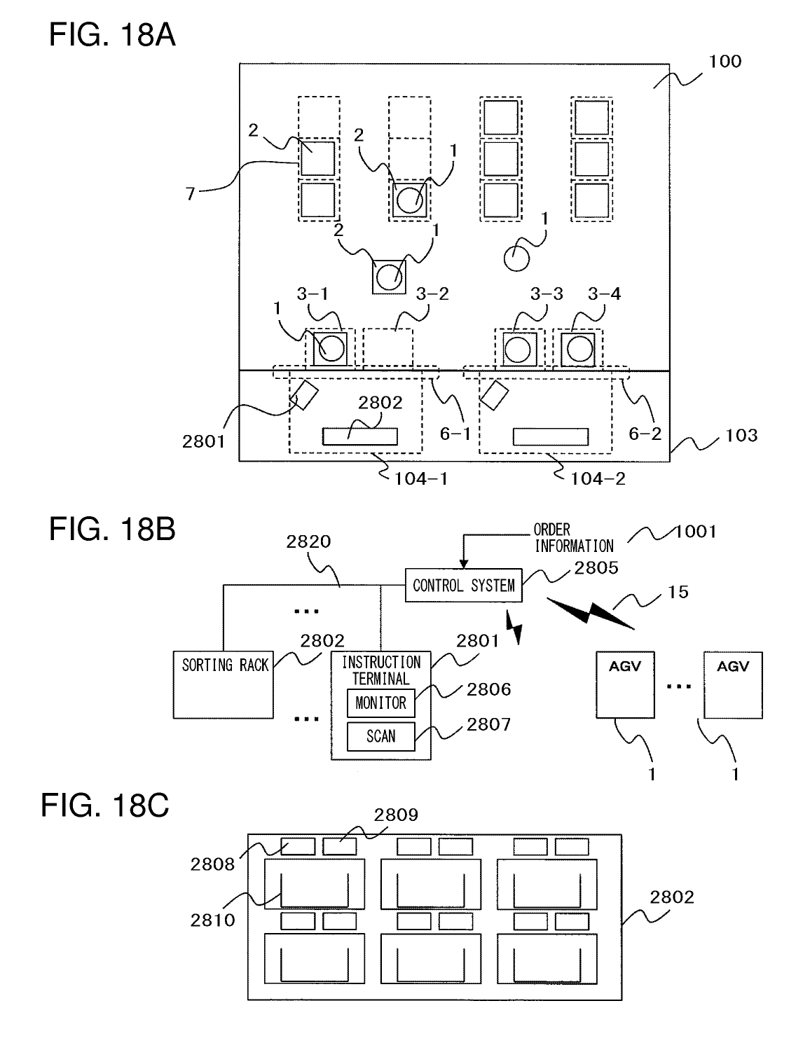

FIG. 18 is a diagram showing Example 2 of the present invention. There is no fixed rack in the warehouse in FIG. 18, as in the case of Patent Literature 1. A picking station 104, which corresponds to the “inventory station” in Patent Literature 1, is the part to which the present invention is applied. One or more picking stations 104 are installed in a picking station area 103 (FIG. 18 shows an example in which two picking stations 104 are installed). The picking station is the facility for picking products of one type (or sometimes a plurality of types) at each of the times from the rack the AGV has transported, and it is the area in which these are placed. In Patent Literature 1, one picking location is provided for one picking station (“inventory station” in Patent Literature 1). On the other hand, in the present invention, a plurality of picking locations are present for one picking station (for example, in FIG. 18, two picking locations 3-1 and 3-2 are present for the picking station 104-1).

The picking station is provided with an instruction terminal 2801 and a sorting rack 2802. The instruction terminal 2801 and the sorting rack 2802 are connected to the control system 2805 by a wired network 2820. As shown in FIG. 18(b), the instruction terminal is provided with a monitor 2806 and a barcode scanner 2807 as in the case of the picking terminal 5. A picking worker is present within the picking station 104, taking a product of one type instructed by the instruction terminal 2801 from the movable rack in the picking location specified by the instruction terminal 2801, checking the product by the barcode scanner, and storing the product in the position specified in the sorting rack 2802. In the sorting rack, as shown in FIG. 18(c), the number of products to be thrown in is displayed in an indicator 2808 corresponding to the position of a bucket 2810 provided in the rack. The worker throws the products in and clicks on a throw-in completion button 2809. When all the products of one type taken from the movable rack have been thrown into the sorting rack, the worker clicks on the throw-in completion button for the last throwing. At this time, a control system 2805 of FIG. 18(b) determines that picking is completed, and issues an instruction to transport (remove) the movable rack placed at the picking location. Note that the instruction terminal 2801 and the sorting rack 2802 are connected to the control system 2805 by a wireless network 2820 such as a wireless LAN.

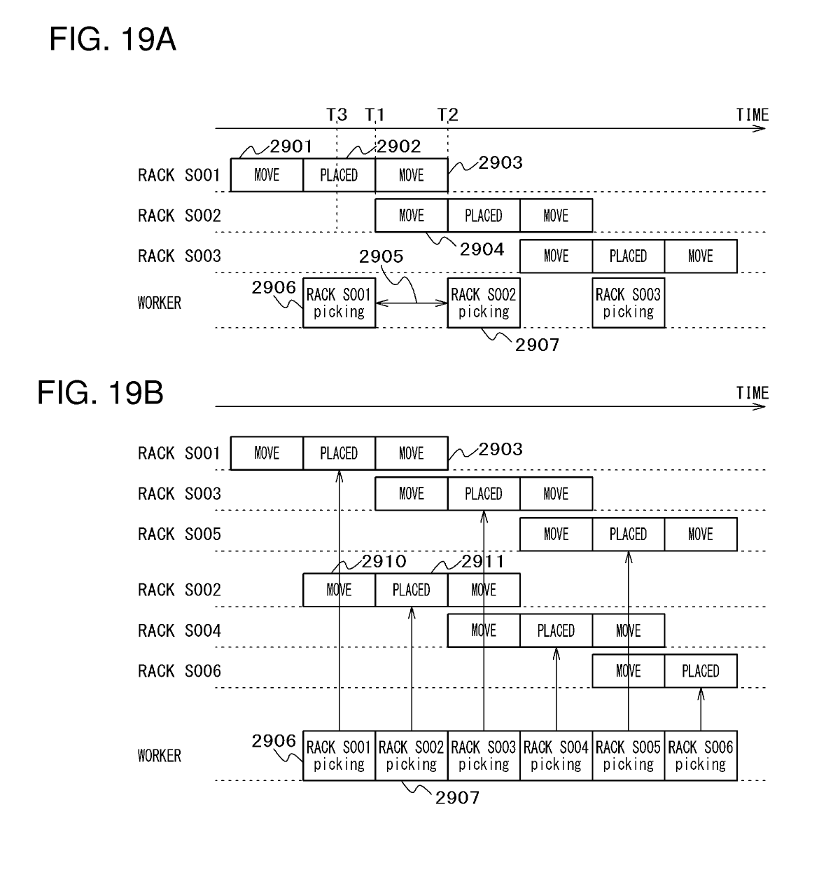

FIG. 19 is a diagram showing the operation of Example 2 of the present invention shown in FIG. 18. FIG. 19(a) is a conventional example of the operation in Patent Literature 1. FIG. 19(a) is a time chart of the operation in which three movable racks are sequentially transported to one picking station (the number of picking location is one). In FIG. 19(a), first the movable rack S001 is transported 2901 and placed 2902. The worker performs picking 2906 during the time when the movable rack S001 is placed 2902. When the picking is completed, the movable rack S001 is moved 2903 (removed), and at the same time, the next movable rack S002 is moved 2904. The timing at which the movable rack S001 starts moving 2903 is the time at which all the products taken from the movable rack S001 have been thrown into the sorting rack 2802. In other words, the worker should have a time 2905 from the time of T1 in FIG. 19(a) until the time of T2 (T2−T1). If the number of products to be taken is one, the completion of the picking can be determined at the time of scanning by the barcode scanner 2807 of the instruction terminal 2806. Thus, the move 2903 of the movable rack S001 can be started at the time of T1 in FIG. 19(a). In this case, the waiting time of the worker is: max ((T2−T1)−(T1−T3), 0), where max (a, b) is a larger value out of a and b, and if T2−T1≦T1−T3, the waiting time of the worker is 0. However, T1−T3 is only the time for the worker to throw one product into the sorting rack and click on the button, while T2−T1 is the time for the AGV to move by the width of the movement. If the AGV is slow in the operation start or if the moving speed is slow, T2−T1>T1−T3, and the waiting time of the worker occurs. As described above, in the conventional method, there is a problem that the waiting time of the worker occurs and the picking operation efficiency is reduced.

FIG. 19(b) is a time chart of the operation in the embodiment to which the present invention shown in FIG. 18 is applied. The movable rack S001, the movable rack S003, and the movable rack S005 are placed at the picking location 3-1. The movable rack S002, the movable rack S004, and the movable rack S005 are placed at the picking location 3-2. During the time when the movable rack S001 is placed at the picking location 3-1 and is picked, the movable rack S002 is moved to the picking location 3-2 and is placed. If the movable rack 5002 is placed before the picking from the movable rack S001 is completed, the worker can perform the picking of the movable rack S002 just after the completion of the picking of the movable rack S001. In this way, by applying the present invention, it is possible to reduce the waiting time 2905 that has occurred in FIG. 19 (a), to zero. As a result, the operational efficiency is significantly increased.

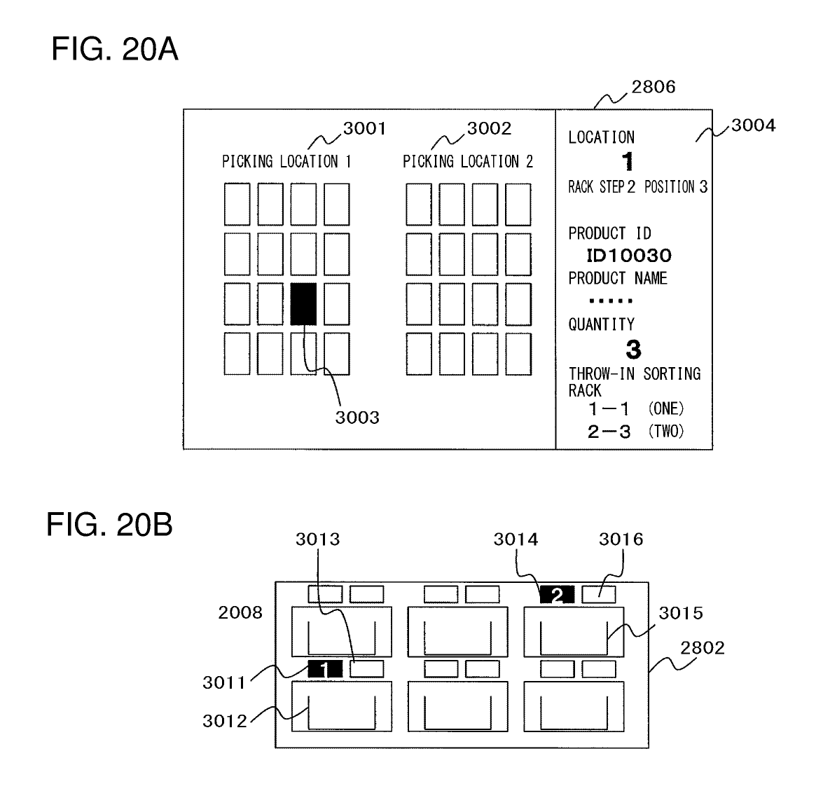

FIG. 20(a) is an example of the display screen of the monitor 2806, in which a schematic view 3001 of the movable rack placed at the picking location 3-1 is displayed on the left side, and a schematic view 3002 of the movable rack placed at the picking location 3-2 is displayed on the right side. An inverting part 3003 shows the position of the rack of the product to be picked. The example of the figure shows that the product located in the second from the bottom and the third from the left in the picking location 3-1 is picked. On the right side of the screen, information 3004 including the number of products to be picked is displayed.

FIG. 20(b) is a display example of the sorting rack 2802 that corresponds to FIG. 20(a). With respect to the three products picked as shown in FIG. 20(a), one of the three products, which is the number indicated by an indicator 3011, is thrown in a bucket 3012 and a throw-in completion button 3013 is clicked on. After checking that the number of the remaining products matches the number indicated by an indicator 3014, the two products are thrown in a bucket 3015, and a throw-in completion button 3016 is clicked on.

FIG. 18 shows the case in which the number of picking locations per picking station is two. However, the operation is the same with three or more picking locations per picking station. In particular, when the movement of the AGV takes longer time than the picking performed by the worker or when the picking time of the worker is much shorter, the waiting time of the worker can be reduced if the number of picking locations is set to three or more. Further, it is assumed in FIGS. 18 and 19 that the AGV is always in a ready-to-transport state below the movable rack placed at the picking location (namely, the state in which the AGV lifts up the movable rack, or in which the movable rack is lifted down but the AGV stands by just below the movable rack). When the number of picking locations per picking station is set to three or more, the time from when a certain movable rack is placed at the picking location until the picking is finished is relatively long. Thus, the AGV that has transported the movable rack can lift down the movable rack and transport another rack. With the process described above, it is possible to reduce the number of ready-to-transport AGVs in the picking location. As a result, it is possible to reduce the number of AGVs required for the picking operation in the whole warehouse as compared to the case of the same delivery processing volume, namely, the case of transporting the same number of movable racks.

In the example of FIG. 20(a), which picking location the rack to be picked is present in is displayed on the monitor 2806 of the instruction terminal. However, the present invention also includes providing a display device or light emitting device corresponding to each picking location near the picking location, to perform display or emit light in the vicinity of the actual movable rack. In this case, it is easy to make a physical correspondence between the display or light emitting part and the movable rack on which picking is actually performed. Thus, the worker can easily determine which picking location from which to pick. This allows for reducing the number of picking errors, increasing the efficiency of the operation, or other effects.

### REFERENCE SINGS LIST

1: AGV
2: movable rack
3: picking location
4: fixed rack
5: picking terminal
6: picking line
7: movable rack location
8: fixed rack location
11: monitor
12: barcode scanner
13: bucket
14: end button
15: wireless network
20: worker
100: AGV area
101: picking area
102: switching area
104: picking station
1000: control system
2501: high movable rack
2502: stand
2602: mezzanine
2801: instruction terminal
2802: sorting rack

1. A picking system comprising:
a movable rack that can be moved;
an automated guided vehicle (AGV) for transporting the movable rack;
an AGV area in which the AGV transports the movable rack;
a picking area that abuts the AGV area and is provided for workers to perform picking operations; and
two or more picking locations, each of which is located within the AGV area in the position abutting the picking area to temporarily place the movable rack.

2. The picking system according to claim 1, further comprising a control system and a picking terminal,
wherein the control system is connected to the AGV and the picking terminal.

3. The picking system according to claim 1,
wherein the picking system detects that the movable rack from which to pick is placed at the picking location, and notifies the picking terminal, which performs picking from the movable rack, of the fact that picking is available.

4. The picking system according to claim 1,
wherein the picking system notifies the picking terminal which performs picking from the movable rack, before the movable rack from which to pick is placed at the picking location, of the estimated amount of time required to complete the disposition of the movable rack, or the scheduled time at which the movable rack is placed.

5. The picking system according claim 1,
wherein a switching area, which can switch between the function of the AGV area and the function of the picking area, is provided between the AGV area and the picking area.

6. The picking system according to claim 1,
wherein the picking system, as the picking location, categorizes products, determines the picking location for each category, and places the movable rack.

7. The picking system according to claim 1,
wherein the picking system, as the picking location, selects the picking location close to the position in which a worker is present, and places the movable rack.

8. The picking system according to claim 1,
wherein the height of the movable rack is higher than the range that the worker can reach, and
wherein a stand on which the worker climbs is provided in the picking location.

9. A picking system comprising:
a movable rack that can be moved;
an AGV for transporting the movable rack;
an AGV area in which the AGV transports the movable rack;
a picking station abutting the AGV area; and
a picking location that is located at an accessible distance from the picking station to place the transported movable rack,
wherein two or more picking locations are present in one picking station.

10. The picking system according to claim 9,
wherein the picking station comprises an instruction terminal and a sorting rack that are connected to a control system.
